(19) United States
(12) Patent Application Publication
(10) Pub. No.: US 2026/0071594 A1
(43) Pub. Date: Mar. 12, 2026

(54) METHOD, APPARATUS AND COMPOSITION FOR PROPULSION GRADE HYDROGEN PEROXIDE HEAVY IN-ORGANIC STABILIZATION USE IN ROTATING DETONATING ROCKET ENGINES & LONG-TERM STORAGE IN PROPELLANT MANAGEMENT SYSTEMS

(71) Applicant: VENUS AEROSPACE CORP, Houston, TX (US)

(72) Inventor: Eric John Wernimont, Houston, TX (US)

(21) Appl. No.: 18/809,157

(22) Filed: Aug. 19, 2024

Related U.S. Application Data
(63) Continuation-in-part of application No. 17/813,261, filed on Jul. 18, 2022.

(51) Int. Cl. F02K 9/42; C06B 43/00; F02K 9/66

(52) U.S. Cl. CPC F02K 9/425; C06B 43/00; F02K 9/66

(57) ABSTRACT

Disclosed is a stabilizer composition for rocket grade hydrogen peroxide (H₂O₂) which is not detrimental to the combustion performance of RDREs and not detrimental to the decomposition performance of catalyst beds while simultaneously greatly increasing the storability of H₂O₂ in rocket propellant management systems including but not limited to tankages and regenerative cooling combustion chambers.

### CROSS REFERENCE TO RELATED APPLICATION

This application is a continuation-in-part of U.S. patent application Ser. No. 17/813,261, filed Jul. 18, 2022, entitled “Stabilized Peroxide Rotating Detonation Rocket Engine”, the entire contents of which are incorporated herein by reference.

### FIELD OF THE DISCLOSURE

The embodiments of the present disclosure are generally directed toward the field of hydrogen peroxide propulsive systems such as rockets, torpedoes, and fuel cells. Specifically, the disclosure is intended to increase storage time for hydrogen peroxide in a propellant management system that is then used in a Rotating Detonation Rocket Engine (RDRE) without detriment to the performance efficiency of the rocket engine nor the overall propulsive system functions such as monopropellant thrusters, gas generators and/or regenerative chamber nozzles, for example.

### BACKGROUND AND SUMMARY

Embodiments of the present invention relate to propellant grade H₂O₂ which can be of concentration ranging from 70% to 100%, however 90% is denoted as the preferred concentration as a compromise between energy content and commercial availability. As such, the preferred embodiment utilizes 90% H₂O₂ oxidizer for an RDRE using propane or kerosene as a fuel, for example.

All commercially available hydrogen peroxide includes trace chemical additions that are known in the art as stabilizers. One definition for stabilizers are chemicals that are added to a hydrogen peroxide solution not because hydrogen peroxide is inherently unstable but to thwart or completely mitigate the contamination inherent in manufacturing, handling, and storage from acting in a catalytic manner and thereby decomposing the hydrogen peroxide. Thus, an entire art of stabilizers tuned to various applications and needs in terms of hydrogen peroxide contact duration, contact material type, contact surface area to volume and application including specifically the temperatures of the fluid/contact has been conceived for the many industries and niche uses.

In the United States propellant grade hydrogen peroxide is generally acquired against a military specification (MIL-PRF-16005 rev F) having a relatively low stabilizer concentration.

The present disclosure seeks to define a stabilizer concentration and composition for rocket grade hydrogen peroxide which are not detrimental to the combustion performance of RDREs and not detrimental to the decomposition performance of catalyst beds while simultaneously greatly increasing the storability of hydrogen peroxide in rocket propellant management systems including but not limited to tankages and regenerative cooling combustion chambers.

In one aspect of the disclosure, H₂O₂ is used as a coolant in a regeneratively cooled system such as combustion chambers and nozzles and/or as a monopropellant in a catalyst bed and/or as an oxidizer in a combustion device. The disclosed stabilizer chemistry composition is specifically tuned for long-term storage (many years) in typical propulsive tank materials of construction such as bare aluminum, e.g., 1060, 5254, 6061, 7075, 2024, and 2014, with no surface treatment and also in passivated or anodized states, and also has a notable increase in storability for materials such as stainless steels, e.g., 304, 316, 347, and 17-4, and high temperature-resistant metals, e.g., Inconel X, Inconel 625, Inconel 718, Rene 41, and Invar. The high temperature-resistant metals could be used for more than just “gas and go” (minimal storage times) applications of H₂O₂ storage tanks which would prove especially useful for hypersonic military applications wherein the vehicle would become very hot from hypersonic aerodynamic heating. The disclosed stabilizers should also reduce reactivity of H₂O₂ with typical materials of construction for structural and regenerative chambers such as nickel/nickel alloys, e.g., Inconel 625, and Inconel 718, and copper and copper alloys, e.g., GRCop42 and C18150. The disclosed stabilizer chemistry should increase storability while having negligible determent to rocket performance of catalytic bed for monopropellant applications of gas generators or thruster and, also as an oxidizer for main combustion.

In one aspect of the present disclosure, we provide a stabilized solution of 70% to 100% of H₂O₂, comprising as a stabilizer at least 5 ppm of a nitrate (NO₃⁻¹), at least 1 ppm of a phosphate (PO₄⁻³), and at least 4 ppm of tin (Sn) wherein the stabilized solution is at least in part the oxidizer in an RDRE.

In one aspect of the disclosure the Sn and the PO₄⁻³ are present in a mass ratio of 10 to 0.5.

In yet another aspect of the disclosure, the stabilizer comprises 800 ppm NO₃⁻, 50 ppm PO₄⁻³, and 500 ppm Sn or in the same proportion up to a maximum of 2000 ppm Sn.

In a further aspect of the disclosure, NaNO₃ is a source of the NO₃⁻, Na₂HPO₄·12H₂O is a source of the PO₄⁻³, and K₂SnO₃·3H₂O is a source of the Sn.

In still yet another aspect of the disclosure, the stabilizer comprises at least 75 ppm NO₃⁻, at least 20 ppm PO₄⁻³, and at least 20 ppm Sn, by mass.

The present disclosure also provides a rocket propellant management system comprising the stabilized solution of 70% to 100% H₂O₂ as above described, in a tank.

In one aspect the propellant management system is configured for use with a rocket engine, wherein the rocket engine comprises one or more monopropellant thrusters, and a catalyst bed comprised at least in part of silver or a silver alloy.

In another aspect of the disclosure the propellant management system is configured for use with at least one gas generator, and a catalyst bed comprised at least in part of silver or a silver alloy.

In yet another aspect of the disclosure, the propellant management system is configured for use with an on-board H₂O₂ tank, wherein the on-board H₂O₂ tank is formed of a metal or metal alloy selected from the group consisting of an aluminum alloy, stainless steel, nickel and a nickel alloy.

In one aspect of the disclosure, the rocket engine comprises an RDRE.

In another aspect of the disclosure the H₂O₂ is decomposed into superheated steam and oxygen, and the superheated steam and oxygen are mixed with a rocket propellant in the RDRE.

In still another aspect of the disclosure, the H₂O₂ is used as a coolant in heat exchange with a regeneratively cooled nozzle and/or combustion chamber of the RDRE. In such aspect, the regeneratively cooled nozzle and/or combustion chamber may include cooling channels that are coated or plated at least in part with tin.

In still another aspect of the disclosure, the regeneratively cooled nozzle and/or the combustion chamber of the RDRE are formed of a metal selected from the group consisting of aluminum alloy, stainless steel, copper, a copper alloy, nickel and a nickel alloy.

In still another aspect of the disclosure, the RDRE includes flow conduits and/or flow control valves that are formed at least in part of a metal alloy selected from the group consisting of an aluminum alloy, stainless steel, nickel and a nickel alloy.

In still yet another aspect of the disclosure, the RDRE has two or more detonation chambers.

The present disclosure also provides a method for stabilizing propulsion grade H₂O₂ for use in an RDRE, which method comprises adding to the H₂O₂ a stabilizer composition comprising at least 5 ppm of a nitrate (NO₃⁻), at least 1 ppm of a phosphate (PO₄⁻³), and at least 4 ppm of tin (Sn) by mass.

In one aspect of the method, NaNO₃ is a source of the NO₃⁻, Na₂HPO₄·12H₂O is a source of PO₄⁻³, and K₂SnO₃·3H₂O is a source of the Sn.

In another aspect of the method, the stabilizer composition comprises at least 75 ppm NO₃⁻, at least 20 ppm PO₄⁻³, and at least 20 ppm Sn, by mass.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the present disclosure will be seen from the following description, taken in connection with the accompanying drawings, wherein:

FIG. 1 is a schematic diagram of a pressure fed blowdown H₂O₂ propellant management system which feeds a monopropellant thruster and a decomposition catalyst bed which decomposes the hydrogen peroxide exhausting the resultant gases into an RDRE where the hydrogen peroxide gases are mixed and detonated with other propellants (other propellants management system, not show for simplicity), fuels, for example in accordance with the present disclosure;

FIG. 2 is a schematic diagram of a pump fed H₂O₂ propellant management system which feeds a monopropellant thruster and a regeneratively cooled nozzle-chamber which is in further fluid communication with a liquid RDRE injector wherein the liquid hydrogen peroxide is mixed and detonated with other propellants (other propellants management system, not show for simplicity), fuels, for example. Additionally a decomposition catalyst bed which decomposes the hydrogen peroxide exhausting the resultant gases into the RDRE device which is utilized for ignition either with or without other propellants such as a fuel, for example in accordance with the present disclosure; and

FIG. 3 is a schematic diagram of a H₂O₂ propellant management system tanking method in accordance with the present disclosure.

### DETAILED DESCRIPTION OF THE DISCLOSURE

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer, or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, “stabilizer” refers to compounds, elements and chemicals that are added to a H₂O₂ solution to mitigate the contamination inherent in manufacturing, handling, and storage from acting in a catalytic manner and decomposing the H₂O₂. Unless specifically stated otherwise the present disclosure expresses the concentration thereof on a mass basis, for example, in terms of parts per million (ppm). Often nitrate (NO₃⁻) is considered a corrosion inhibitor but is considered a “stabilizer”in the current disclosure.

As used herein, “H₂O₂ solutions” refers and is understood to include mixtures of liquid H₂O₂ and liquid water.

As used herein, “propulsion grade H₂O₂” refers to H₂O₂ solutions that are at least 70% weight percent H₂O₂.

As used herein, RDRE refers to an engine using a form of pressure gain combustion, where one or more detonations continuously travel around an annular channel, which combusts a mixture of an oxidizer and a fuel. For example, a mixture of liquid 90% H₂O₂ (an oxidizer) and JetA (a fuel) in mass proportion of 8:1 would be such a mixture.

As used herein, “detonation” refers to supersonic combustion in the propellant medium being combusted and “deflagration” refers to subsonic combustion in the propellant medium being combusted.

As used herein, “valves”should be understood to include “one or more valves”.

As used herein the term “stabilized H₂O₂ solution” or “stabilized hydrogen peroxide” means H₂O₂ that is stabilized against decomposition during storage using a composition containing NO₃⁻, PO₄⁻³ and Sn.

As used herein, “catalyst or catalyst bed” refers to material that assists to lower the energy required for a reaction to take place or speed up the reaction; however, it does not chemically participate in the reaction as in not consumed by the reaction, and is generally directed at the decomposition of H₂O₂ into oxygen, water, and energy. Also catalyst beds may be referred to as “gas generators” since the they result in generation of a gas (oxygen and super-heated steam) from decomposition of the liquid H₂O₂.

As used herein, “regenerative or regenerative cooling” refers to a rocket in which some or all the propellant is used to cool the combustion chamber and/or the expansion nozzle of the rocket.

As used herein, “tank”, or “tankage” refers to a vessel or tank used for storage of a propellant or propellants. “Tankage” generally refers to the largest volume element in a propellant management system. And is generally also known as the storage location for the longest time duration storage of propellant in a propellant management system.

As used herein, “propellant management system” includes systems that can pump or pressure feed a fluid and which include tankage, flow control devices such as valves and orifices, and with fluid connections such as pipes and tubing. Such systems are used to move fluids such as propellants and oxidizers around under specified pressures and temperature ranges and flow rates. The entire system is intended to feed a combustion device and/or a power device.

As used herein, “long-term storage”refers to time periods longer than 1 year.

As used herein, “propellant” refers to a mass that is exhausted to produce thrust and/or energy. Propellants can be fuels such as kerosene (Jet A, Jet A-1), propane, or any other organic composition. Additionally, fuels can also be inorganic such as hydrogen or ammonia. Propellants also may comprise oxidizers such as oxygen, nitric acid, or H₂O₂. Additionally, sometimes propellants can also be inert fluids that can also serve as pressurants, i.e., helium, nitrogen, etc.

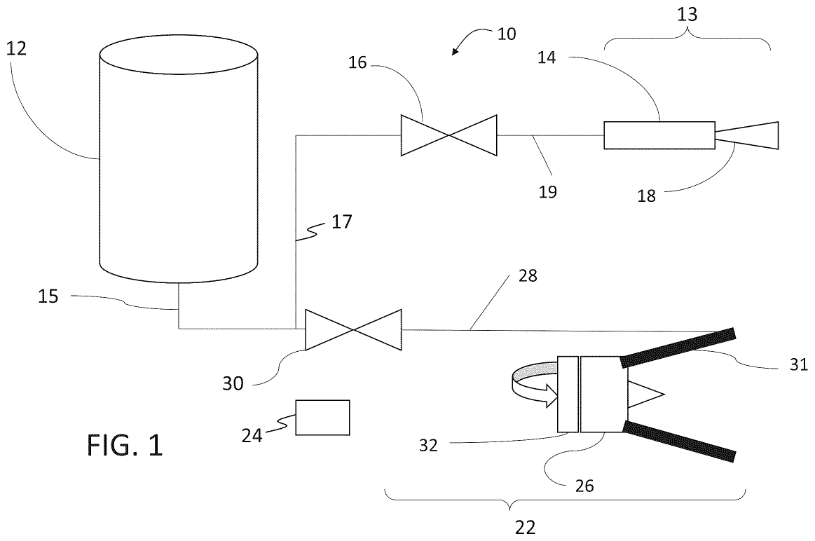

FIG. 1 schematically illustrates a H₂O₂ propellant management system 10 for providing a highly stabilized H₂O₂ oxidizer to a rocket having a fuel store and a rocket engine in accordance with the present disclosure. A person of ordinary skill in the art will understand that the schematic diagram shown in FIG. 1 is simplified so as not to obscure the disclosure with unnecessary detail. There are also several valves, ancillary lines, and by-pass pathways, not shown for simplicity.

Propellant management system 10 comprises a storage tank 12 formed of aluminum 6061-T6, configured for storing stabilized liquid H₂O₂ comprising 90% liquid H₂O₂ stabilized by 800 ppm NO₃⁻, 50 ppm PO₄⁻³ and 500 ppm Sn. Propellant management system 10 is configured to feed a monopropellant thruster 13 and an RDRE 22.

Monopropellant thruster 13 comprises a catalyst bed 14 formed of silver through which is fed liquid H₂O₂ from storage tank 12 via conduits 15, 17 and 19 under control of valve 16. The H₂O₂ undergoes decomposition in catalyst bed 14 into superheated steam and oxygen which is expelled via a nozzle 18, producing thrust.

RDRE 22 uses a propellant combination that includes a fuel source stored in on-board fuel tank 24 and delivered to RDRE reaction chamber 26 via feedlines (not shown). Liquid H₂O₂ is passed from H₂O₂ storage tank 12 via conduits 15 and 28 under control of valve 30. The liquid H₂O₂ is passed from conduit 28 through passages (not shown) in RDRE exhaust nozzle 31 to regeneratively cool the exhaust nozzle 31 and RDRE combustion chamber 26. Exhaust nozzle 31 and RDRE combustion chamber 26 may at least be formed by a 3-D printing process. The liquid H₂O₂ is then passed to a catalyst bed 32 formed of silver in which the H₂O₂ is decomposed into superheated steam and oxygen. The superheated steam and oxygen are then mixed with fuel such as Jet A within the RDRE from on-board fuel tank 24 and the fuel combusted in the RDRE reaction chamber 26. The propellant combination undergoes detonation combustion and is exhausted out exhaust nozzle 31 producing thrust.

In this instant embodiment H₂O₂ storage tank 12 is pressurized with a pressurant, such as gaseous helium or gaseous nitrogen which provides the energy to move the liquid H₂O₂ throughout the propellant management system 10. A feature and advantage of the instant disclosure is that the liquid H₂O₂ is first passed in heat exchange to regeneratively cool exhaust nozzle 31 before the H₂O₂ is decomposed and introduced into the RDRE reaction chamber 26. RDRE reaction chamber 26 is formed of Inconel 718, and the RDRE catalyst bed 32 is formed of silver.

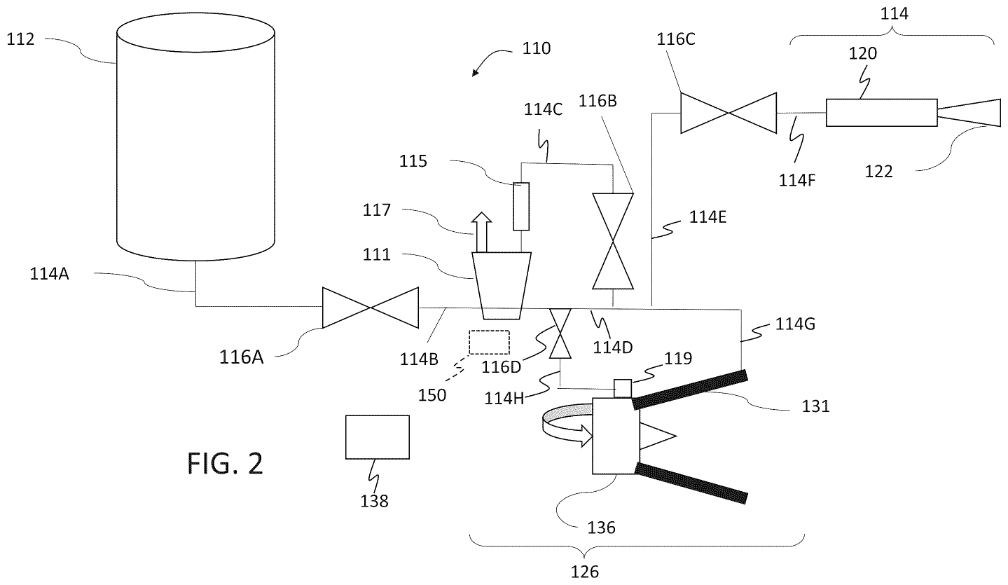

FIG. 2 schematically illustrates another embodiment of the H₂O₂ propellant management system 110 for use with stabilized 90% H₂O₂ in accordance with the present disclosure. H₂O₂ propellant management system 110 includes an H₂O₂ storage tank 112 and all other elements shown in FIG. 1 and additionally includes an on-board fuel tank 138, monopropellant thruster 114, and an RDRE 126. Storage tank 112 is in fluid communication with the monopropellant thruster 114 and the RDRE 126 via flow lines 114A, 114B, 114D, 114E, 114F, 114G and several isolation valves 116A and 116C as will be described below.

Isolation valves 116A and 116B are in fluid communication via flow lines 114B and 114C with a catalyst bed gas generator 115 in which the liquid H₂O₂ is decomposed into superheated steam and oxygen. The superheated steam and oxygen are then used to drive a turbine or turbopump 111 which provides shaft power to the liquid pump having suction at 114B and discharge at 114D. The gas generator exhaust from turbine pump 111 is dumped overboard via exhaust outlet 117, which optionally may be fitted with a nozzle (not shown) to provide additional thrust.

Liquid H₂O₂ is also passed via flow lines 114A, 114B, 114D, 114E, 114F and valve 116C through catalyst bed 120 of monopropellant thruster 114, where the H₂O₂ undergoes decomposition into superheated steam and oxygen, and is exhausted out of nozzle 122 producing thrust.

The bulk of the H₂O₂ is passed via flow lines 114A, 114B, 114D and 114G through passages (not shown) in the RDRE 126 exhaust nozzle 131 to regeneratively cool the nozzle 131. The liquid hydrogen peroxide is then directed into the injection portion of the reaction chamber of the RDRE 136 where it is mixed with liquid fuel such as Jet-A from on-board fuel tank 138 (for clarity fuel propellant management system not show) being ignited from ignitor torch 119 undergoes detonation combustion and is exhausted out nozzle 131 producing thrust.

Discharge from turbine pump 111 is passed via valve 116D and flow line 114H to the catalyst bed ignitor torch 119 which decomposes the H₂O₂ into superheated steam and oxygen, which is then utilized as an ignition torch in the reaction chamber of RDRE 136.

Hydrogen peroxide propellant management system 110 optionally may include an electric motor shown in phantom at 150 for providing the turbine pump 111 with start power.

The tank 112 is formed of Inconel 718, catalyst bed 120 comprises a silver or silver alloy catalyst, and the regeneratively cooled exhaust nozzle 131 and the rection chamber is formed of GRCop-42 with a nickel outer shell.

In another embodiment the turbine pump 111 is a positive displacement reciprocating pump.

In another embodiment the catalyst bed ignitor torch 119 has fuel (fuel propellant management system not shown for clarity) mixed and combusted downstream but before entering the RDRE reaction chamber 136 to increase the torch flame temperature where the fuel is hydrogen, Jet A or propane, for example.

In another embodiment the regeneratively cooled exhaust nozzle and the RDRE reaction chamber 136 is comprised of a copper alloy which is tin plated in the flow channels.

In one embodiment the regeneratively cooled exhaust nozzle and the RDRE reaction chamber 136 is an apparatus that contains an inner body and an outer body that is regeneratively cooled by hydrogen peroxide.

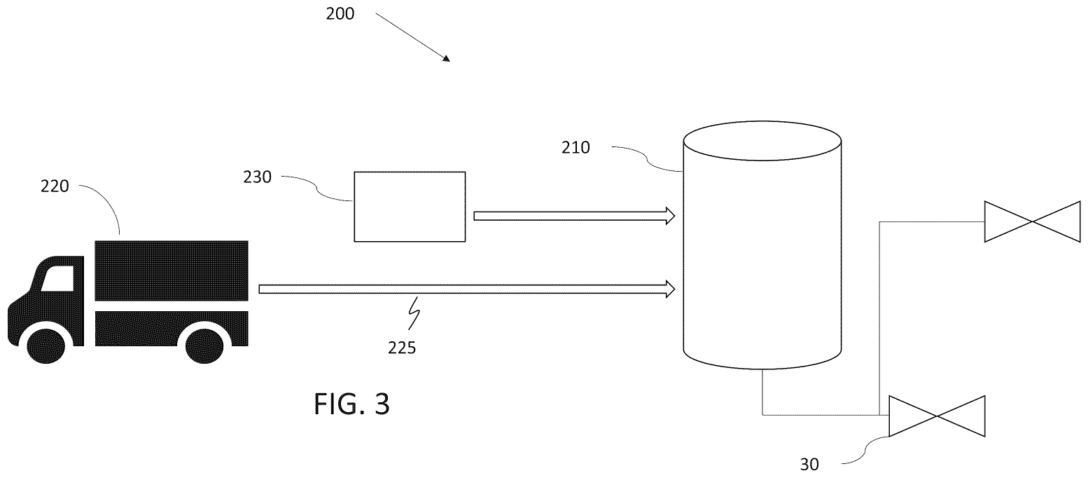

FIG. 3 illustrates a method of adding the stabilizers composition to liquid H₂O₂ taught in the current disclosure. The stabilizer composition may be added to the propellant management system tankage first or at the same time as the H₂O₂ from a factory delivery is added to the system thereby assuring mixing and achieving the final desired stabilizer concentrations as taught in the current disclosure. The stabilizer composition concentration may be achieved by a deposit of the stabilizer composition at or near a tank of the propellant management system. In one embodiment the stabilizer composition may be added to a fill line of the tank prior to movement of the H₂O₂ into the propellant management system. In such embodiment the stabilizer and the H₂O₂ may be mixed together by a static blade mixer in the fill line. The then stabilized H₂O₂ will be stored in the tank and the fluid communication lines up to and including the isolation valves 30 so long as the isolation valves are in the closed position in accordance with the present disclosure.

FIG. 3 depicts a preferred embodiment of a H₂O₂ propellant management system tanking method 200 implementing certain aspects of the present disclosure. A tank 210 filling or tanking method is shown wherein as-delivered H₂O₂ 220 which conforms to MIL-PRF-16005 Rev F is flowed via a conduit 225 into a vented tank 210 at or near the bottom of the tank 210. Tank 210 is filled between 10% and 50% full and the stabilizer composition from tank 230 is then added to tank 210. The remainder of the of the as-delivered H₂O₂ 220 is flowed into the tank 210 filling to a minimum of 90% of the volume of a tank 210. The stabilizer composition is added in the form of Sodium Nitrate (NaNO₃), Sodium phosphate dibasic dodecahydrate (Na₂HPO₄·12H₂O) and Potassium Stannate Trihydrate (K₂SnO₃·3H₂O). Adding the stabilizer composition partway through the filling process permits intimate mixing of the H₂O₂ and the stabilizer composition during the tanking process.

Alternatively, the stabilizer composition may be flowed into tank 210 first, and the liquid H₂O₂ then flowed into the tank 210. Another option is to add the stabilizer composition into conduit 225, before flowing the H₂O₂ through the conduit 225.

The final tanked stabilizer concentration in the liquid H₂O₂ in tank 210 is nitrate (NO₃⁻), phosphate (PO₄⁻³) and tin (Sn) hat are 800 ppm, 50 ppm and 500 ppm, by mass, respectfully. The H₂O₂ propellant management system 200 is similar to propellant management system shown in FIG. 1, up to and including the valve or valves 30.

Alternatively, the final tanked stabilizer concentration in the H₂O₂ peroxide in tank 210 of nitrate (NO₃⁻), phosphate (PO₄⁻³) and tin (Sn) are 160 ppm, 10 ppm and 100 ppm, respectfully. In another embodiment the stabilizer composition can be added in the form of other compounds containing Nitrate, Phosphate or Stannate. In another embodiment the stabilizer composition is added at the factory and is delivered to the H₂O₂ propellant management system at the preferred final stabilizer concentration.

The following examples are provided to better illustrate the disclosure.

Example 1: RDRE combustion tests were conducted on a heat sink copper chamber with a single detonation channel diameter of approximately 3.75 inches. Liquid H₂O₂ conforming to MIL-PRF-16005 Rev F type 90 (90-91.5%) grade HP (nitrate<5 ppm, phosphate<1 ppm and tin<4 ppm) was run through a silver-based catalyst bed with the exhaust of oxygen and superheated steam entering the detonation channel wherein it was mixed with propane. The oxidizer (decomposed hydrogen peroxide) and fuel (propane) mixture was ignited with a gaseous hydrogen and gaseous oxygen torch and the produced combustion underwent the desired rotating detonation combustion behavior producing detonation channel pressures and thrust for several seconds after the ignitor was stopped. Many successful RDRE tests were performed at various oxidizer-to-fuel ratios. Further successful RDRE tests were performed without the use of a catalyst bed, meaning liquid H₂O₂ was directly injected into the detonation channel. Further tests using Jet-A as the fuel (in place of propane) were successfully run in the RDRE tests both with the aforementioned catalyst bed and without it injecting liquid H₂O₂ directly into the detonation channel.

Example 2: The test apparatus including the ignition torch of Example 1 was utilized in repeat test at near optimum oxidizer-to-fuel ratio involving liquid H₂O₂ and propane. The liquid H₂O₂ conforming to MIL-PRF-16005 Rev F was doped on site and mixed prior to tanking in the test stand with stabilizer. The final stabilizer level was roughly equivalent to that identified in MIL-H-22868 of 1961 grade 90E. More specifically, the approximate stabilizer level was 22 ppm Sn and PO₄⁻³ and 79 ppm NO₃⁻. The compounds Sodium Nitrate (NaNO₃), Sodium phosphate dibasic dodecahydrate (Na₂HPO₄·12H₂O) and Potassium Stannate Trihydrate (K₂SnO₃·3H₂O) were added to achieve the end stabilizer levels. Successful RDRE combustion was achieved with no apparent degradation in performance was observed from a chamber pressure nor thrust standpoint.

Example 3: Beaker tests were performed to confirm no obvious influence on corrosion nor concentration loss were conducted with very heavy stabilization. Two 250 mL glass beakers were filled half full of 90% H₂O₂ conforming to MIL-PRF-16005 Rev F type 90 grade HP. To one of the beakers, the compounds of Sodium Nitrate (NaNO₃), Sodium phosphate dibasic dodecahydrate (Na₂HPO₄·12H₂O) and Potassium Stannate Trihydrate (K₂SnO₃·3H₂O) were added to achieve stabilizer levels of 800 ppm NO₃⁻, 50 ppm PO₄⁻³ and 500 ppm Sn. The first beaker, where no additional stabilizers were added, roughly 50 mL of that solution was deposited into a 100 mL glass beaker. From the second 250 mL beaker containing the much higher stabilizer levels, roughly 50 mL were deposited into a 100 mL glass beaker. Into each of the 100 mL beakers was deposited aluminum sheet 1/16″×½″×1.5 ″ and aluminum bar ¼″ diam×1.5″ wetted length wherein the total wetted surface area to volume ratio of roughly S/V˜0.3/in. The sheet pieces were 6061-T6 aluminum which were bent into an “S” shape (producing local yielding) and purposely scarred with vice teeth marks to simulate extremes of surface conditions expected in field handing. The bar material was also aluminum of 6061-T6 condition. After 3 months storage at ambient conditions no obvious corrosion was observed on any of the aluminum samples and the higher stabilized H₂O₂ is losing concentration slower as measured by refractometer.

Various changes and advantages may be made in the above disclosure without departing from the spirit and scope thereof. In example, while the foregoing disclosure depicts the rocket engine as being an RDRE, the stabilized H₂O₂ oxidizer of the present disclosure also advantageously may be used in connection with other rocket engines including but not limited to Oblique Detonation Rocket Engines (ODREs), such as described in our copending U.S. application Ser. No. 17/828,868, filed May 31, 2022 (Attorney Docket No. 18875-000003US), the contents of which are incorporated herein in their entirety.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 Propellant management system, hydrogen peroxide
12 storage tank
13 monopropellant thruster
14 catalyst bed
15 conduit
16 valve
17 conduit
18 nozzle
19 conduit
22 RDRE
24 on-board fuel tank
26 RDRE reaction chamber
28 conduit
30 valve
31 exhaust nozzle
32 catalyst bed
110 Propellant management system, hydrogen peroxide
111 turbine pump
112 storage tank
114 monopropellant thruster
114A-H flow lines
115 gas generator
116A-D isolation valves
117 turbine exhaust
119 catalyst bed ignitor torch
120 catalyst bed
122 nozzle
126 RDRE
131 nozzle
136 RDRE reaction chamber
138 on-board fuel tank
150 electric motor
200 propellant management system tanking method
210 tank
220 as-delivered H₂O₂
225 conduit
230 tank

### APPENDIX

### U.S. Patent Documents

U.S. Pat No. 3,383,174 May 1968 Carnine et al.
U.S. Pat No. 3,687,627 August 1972 Stalter et al.
U.S. Pat No. 4,320,102 March 1982 Dalton et al.
U.S. Pat No. 5,078,672 January 1992 Doughtety et al.
U.S. Pat No. 6,637,448 October 2003 Naab et al.
U.S. Pat No. 7,169,237 January 2007 Wang et al.
U.S. Pat No. 10,946,359 March 2021 Modroukas et al.
2022/0205412 June 2022 Duggleby
2024/0018067 January 2024 Wernimont et al.

### Other Publications

Anderson, Heister and Kan, Experimental Study of a Hypergolically Ignited Liquid Bipropellant Rotating Detonation Rocket Engine, Journal of Propulsion and Power, Vol 36, No. 6, Nov-Dec 2020.
Ballintyn and Heister, Experimental Study of a Rotating Detonation Rocket Engine Using RP-2 and Hydrogen Peroxide Propellants, AIAA 2024-2249, AIAA SciTech Forum, January 2024,Orlando, FL.
Butler, NF-104: The Flight Proven AR2-3 Rocket Engine and Future Applications, 412TW-PA-22076, Released March, 2022.
Evonik, Hydrogen Peroxide stability and decomposition, https://active-oxygens.evonik. com/en/products-and-services/hydrogen-peroxide/general-information/stability-and-decomposition, as of Oct. 9, 2023.
Kopacz et al., “Hydrogen peroxide—A promising oxidizer for rocket propulsion and its application in solid rocket propellants”, Science Direct, FirePhysChem, Volume 2, Issue 1, March 2022, pages 56-66.
Kubicki, Heister and Anderson, Further Experimental Study of a Hypergolically-Ignited Liquid-Liquid Rotating Detonation Rocket Engine, AIAA 2020-0196, AIAA SciTech Forum, January 2020, Orlando, FL.
McCormick, James C., Hydrogen Peroxide Rocket Manual, FMC Corporation, 1965.
MIL-H-22868, Military Specification Hydrogen Peroxide, E-Stabilized, 70% and 90% (For Torpedo Use), 21 Mar. 1961.
MIL-PRF-16005 Rev E, Military Specification Propellant, Hydrogen Peroxide, 31 Jan., 1968.
MIL-PRF-16005 Rev F, Performance Specification Propellant, Hydrogen Peroxide, 01Aug, 2001.
Rocketdyne, Hydrogen Peroxide Handbook, AFRPL-TR-67-144, July, 1967.
Schumb, Satterfield and Wentworth, Hydrogen Peroxide, chapter 9 Stabilization, Massachusetts Institute of Technology, Report No 45, Nov, 1953.
Sigma-Aldrich, Product Specification: Sodium Nitrate (NaNO3), PRD.3.ZQ5.10000030754
Sigma-Aldrich, Specification Sheet: Sodium phosphate dibasic dodecahydrate (Na2HPO4 12H2O), https://www.sigmaaldrich.com/US/en/specifi cation-sheet/SIGMA/71649, as of Feb. 6, 2024
Sigma-Aldrich, Product Specification: Potassium Stannate Trihydrate (K2SnO3 3H2O), PRD.2.ZQ5.10000038799
Ventura, Long Term Storability of Hydrogen Peroxide, AIAA 2005-4551, 41st AIAA Joint Propulsion Conference, Tucson, AZ July, 2005.
Wernimont, E. and Ventura, M., Catalyst Bed Testing for Development of a 98% Hydrogen Peroxide Procurement Specification, AIAA 2002-3852, July 2002, 38Th Joint Propulsion Conference, Indianapolis, Indiana.
Wikipedia, High-Test Peroxide, https://en.wikipedia.org/wiki/High-test_peroxide #:˜:text=Normal, as of Jan. 10, 2024.
Wikipedia, Regenerative Cooling (Rocketry), https://en.wikipedia.org/wiki/Regenerative_cooling_(rocketry), as of jan n 23, 2024.
Wikipedia, Rotating Detonation Engine, https://en.wikipedia.org/wiki/Rotating_detonation_engine, as of Jan. 19, 2024.
U.S. patent application Ser. No. 17/561,521 (unpublished)
U.S. patent application Ser. No. 17/828,868 (unpublished)

What is claimed:

1. A method for stabilizing propellant grade hydrogen peroxide (H₂O₂) for use as an oxidizer in a rotating detonating rocket engine comprising adding to the propellant grade H₂O₂ a stabilizing composition of nitrate (NO₃⁻), phosphate (PO₄⁻³) and tin (Sn), wherein
a. a concentration of nitrate (NO₃⁻) is 5 ppm or more;
b. a concentration of phosphate (PO₄⁻³) is 1 ppm or more; and
c. a concentration of tin (Sn) is 4 ppm or more.

2. The method of claim 1 wherein the said tin (Sn) to phosphate (PO₄ ⁻³) ratio is 10 to 0.5.

3. The method of claim 1 wherein the said concentration of nitrate (NO₃⁻), phosphate (PO₄⁻³) & tin (Sn) is 800 ppm, 50 ppm & 500 ppm respectively or in the same proportion.

4. The method of claim 3 wherein the maximum tin (Sn) concentration is 2000 ppm.

5. The method of claim 1 wherein the compounds of Sodium Nitrate (NaNO₃), Sodium phosphate dibasic dodecahydrate (Na₂HPO₄ 12H₂O) and Potassium Stannate Trihydrate (K₂SnO₃ 3H₂O) as the compound salt sources for the stabilizer at least in part.

6. A rocket propellant management system for use with propellant grade hydrogen peroxide (H₂O₂) comprising a stabilizing composition of nitrate (NO₃⁻), phosphate (PO₄⁻³) and tin (Sn) wherein:
a. a concentration of nitrate (NO₃⁻) is 75 ppm or more;
b. a concentration of phosphate (PO₄⁻³) is 20 ppm or more; and
c. a concentration of tin (Sn) is 20 ppm or more.

7. The system of claim 6 wherein the said H₂O₂ is used in a monopropellant thruster or plurality of thrusters that utilizes a catalyst bed that is at least in part composed of silver or silver alloy.

8. The system of claim 6 wherein the said H₂O₂ is used in a gas generator or plurality of gas generators that utilizes a catalyst bed that is at least in part composed of silver or silver alloy.

9. The system of claim 6 wherein the said H₂O₂ is used in as a coolant in a regeneratively cooled nozzle and chamber of a rocket engine.

10. The system of claim 9 wherein the said rocket engine is a rotating detonation rocket engine.

11. The system of claim 9 wherein the said regeneratively cooled nozzle and chamber is at least in part composed of aluminum alloy, stainless steel, copper, copper alloy, nickel, or nickel alloy.

12. The system of claim 6 wherein the said regeneratively cooled nozzle and chamber includes cooling channels which channels are at least in part tin plated.

13. The system of claim 6 wherein the said H₂O₂ is used and stored in a tank or plurality of tanks which tanks are at least in part composed of aluminum alloy, stainless steel, nickel, or nickel alloys.

14. The system of claim 6 wherein the system includes inflow lines and flow control components for said H₂O₂ which are at least in part composed of an aluminum alloy, stainless steel, nickel, or a nickel alloy.

15. The system of claim 9 wherein the said nozzle and/or rocket engine chamber are at least in part formed by a 3-D printing process.

16. The system of claim 6 wherein the said stabilizer composition concentrations are achieved by a deposit of the said stabilizer compositions at or near a tank of the said propellant management system.

17. The system of claim 16 wherein the said stabilizer composition is added to a fill line of said tank prior to movement of the said H₂O₂ into said propellant management system.

18. The system of claim 17 wherein mixing of the said stabilizer and said H₂O₂ is performed at least in part by a static blade mixer in the fill line.

19. The system of 16 wherein the said stabilizers composition comprises Sodium Nitrate (NaNO₃), Sodium phosphate dibasic dodecahydrate (Na₂HPO₄ 12H₂O) and Potassium Stannate Trihydrate (K₂SnO₃ 3H₂O).

20. The method of claim 1 wherein the said rotating detonation rocket engine has two or more detonation channels.
